(19) United States
(12) Patent Application Publication
(10) Pub. No.: US 2011/0026860 A1
(43) Pub. Date: Feb. 3, 2011

(54) Method and Apparatus for Implementing Differential Heat Seal Strength in Pouch-Based Diagnostic and Medical Products

(75) Inventors: Jason Anthony Taylor, Vista, CA (US); Michael Scot Poirier, Vista, CA (US); Scott Stephen Breidenthal, Oceanside, CA (US)

Correspondence Address: FISH & ASSOCIATES, PC;ROBERT D. FISH, 2603 Main Street, Suite 1000, Irvine, CA, 92614-6232, US

(73) Assignee: QUALIGEN, INC., Carlsbad, CA (US)

(21) Appl. No.: 12/517,895

(22) PCT Filed: Dec. 6, 2007
(86) PCT No.: PCT/US07/25171

§ 371 Date: Sep. 20, 2010

Related U.S. Application Data
(60) Provisional application No. 60/868,846, filed on Dec. 6, 2006.

(51) Int. Cl. B65D 33/00; B29C 65/02; B65D 30/08

(52) U.S. Cl. 383/210; 156/60; 383/109

(57) ABSTRACT

Devices and methods are contemplated in which pouch-based diagnostic and medical products are formed in a process that allows formation of distinct seals using application of distinct process control variables for the respective seals. Therefore, products having stronger permanent seals and at the same tome frangible seals with controlled breaking characteristics can be prepared in s simple and reproducible manner.

This application claims priority to U.S. provisional patent application with the Ser. No. 60/868846, which was field Dec. 6, 2006.

### FIELD OF THE INVENTION

The field of the invention is medical diagnostic devices using holders having special form (422/058).

### BACKGROUND

Pouch-based diagnostic and medical products are typically formed using heated plates to create the various chambers in the pouch and the “chevrons” or “frangible fluid seals” that reside between the various chambers.

Currently, most pouch-based assay pouches with their various chambers and frangible seals are formed in a single operation in which pressure and heat are applied by a heater plate for a predetermined period of time with the various geometries machined into the face of the planar heater plate. These processes are conventional in the art of pouch manufacture, and exemplary embodiments can be found in U.S. Pat. Nos. 7,055,683, 6,874,300, 4,539,263, and 4,550,141, and U.S. Pat. App. Nos. 2005/0176568, 2005/0034432, 2004/0118710, and 2004/0082455, all of which are incorporated by reference herein. Where a definition or use of a term in a reference, which is incorporated by reference herein is inconsistent or contrary to the definition of that term provided herein, the definition of that term provided herein applies and the definition of that term in the reference does not apply.

While control of pressure and heat for a predetermined period of time often provides adequate and useful seals in conventional methods, various difficulties nevertheless remain. For example, where conventional processes are employed to create a permanent seal area and a frangible seal area in the same pouch, heat and pressure requirements for a permanent seal are typically incompatible with those needed for optimal performance of frangible seals. By the same token, process conditions best suitable for frangible seals are typically achieved by reduction of heat, pressure, and/or time, which tends to compromise strength or minimum rupture force for permanent seals in the same pouch. Thus, while the current manufacturing techniques are adequate, the optimum process parameters to create the permanent chamber seals and the optimum process parameters to form frangible seals are at the opposite ends of the process range.

In yet another known process of forming flexible compartmented reagent containers as described in EP 0972506, two polymer sheets are electron beam treated such as to adhere the sheets to each other. The so treated sheets are then cut to a desired geometry, filling ports are introduced at opposite ends, and the perimeter of the sheets is then heat sealed using a conventional sealing process. Under the pressure of introduction of reagents to the respective ports, the adherent sheets are gradually forced apart. Introduction of the reagents terminates prior to the sheets becoming entirely separated to so form a single pouch with a frangible seal and a permanent perimeter seal. While such method advantageously allows formation of different seals with predefined strengths, various problems nevertheless remain. Among other things, the number and geometries of compartments produced in such manner are limited. Still further, such methods are typically relatively expensive and often require careful selection of materials.

Thus, while various configurations and methods of forming permanent and frangible seals in flexible pouches are known in the art, all or almost all of them, suffer from one or more disadvantages. Therefore, there is still a need for improved configurations and methods of forming permanent and frangible seals in a flexible pouch.

### SUMMARY OF THE INVENTION

The present invention is directed to systems and methods of manufacture of pouch-based diagnostic and medical devices in which a plurality of seals form one or more reagent compartments and one or more frangible seals, wherein the respective seals have optimized characteristics obtained by use of independently controlled process variables during the manufacturing process. Viewed from a different perspective, it should be appreciated that the pouch compartments and frangible seals can utilize different variables, that the independently controlled process variables can be optimized to achieve stronger chamber seals and weaker frangible seals, and that one type of seal can be independently optimized without affecting another type of seal.

In one aspect of the inventive subject matter, a method of producing a pouch having a chamber with a chamber seal and a frangible seal includes a step of providing a first and second film, wherein the first and second film are substantially non-adherent to each other. In another step, the first and second film are positioned such that first and second film contact each other in at least partial overlap, and in yet another step, a different process control variable (temperature, pressure, time) is applied to first and second films to thereby form the chamber and the frangible seal, respectively.

Most typically, at least two or three of the processes control variables are varied in the process of producing the chamber and frangible seals, and it is generally preferred that basic pouch and chamber geometries of the pouch are formed using a first heater plate. After that step, the pouch is indexed to a second heater plate, and the frangible seal is formed using the second heater plate. In especially preferred methods, the step of indexing is performed using registration openings that are formed in the pouch, wherein the registration openings are also usable for registration of the pouch in an analytic device.

Alternatively, the step of applying the different process control variable to first and second films is performed using a heater plate that includes two interleaved pieces in which an outer, larger one of the pieces contains basic pouch and chamber geometries, and in which an inner, smaller one of the pieces contains frangible seal geometries. Similarly, the step of applying the different process control variable to first and second films may also be performed using a heater plate that includes cooling zone geometries at locations of different frangible seal geometries, and/or may be performed using a heater plate that includes heating elements that are separately controlled (e.g., separate control of time and temperature). Where desirable, and regardless of the manner of formation of the different seals, it is contemplated that an additional different process control variable to first and second films to thereby form an additional frangible seal, wherein the frangible seal and the additional frangible seal have different opening characteristics.

Consequently, flexible pouches are contemplated that are fabricated according to the methods presented herein. Especially preferred pouches may further include one or more registration openings that are suitable for registration of the pouch in an analytic device, and may still further include an additional frangible seal that has different opening characteristics relative to another frangible seal.

Various objects, features, aspects and advantages of the present invention will become more apparent from the following detailed description of preferred embodiments of the invention.

### DETAIL DESCRIPTION

The inventors have discovered that pouch-based diagnostic and medical devices can be manufactured in a simple and efficient process that allows separate optimization of the seal characteristics for compartments and flow control elements formed from such seals. More particularly, contemplated methods employ one or more heater plates that have co-registered features to allow independent and separately controlled application of pressure and heat for predetermined periods of time, which advantageously allows formation of seals with controlled characteristics.

In one aspect of the inventive subject matter, two separate heater plates are employed to form the permanent and frangible seals, respectively. Most typically, the first heater plate in such approach is positioned in a distinct forming station that is dedicated to the different pouch geometries for the permanent seals. Thus, the basic pouch and chamber geometries are formed using the first heater plate. The pouch is then indexed to the second heater plate in a further distinct forming station where the frangible seal geometries are formed. Preferably, co-registration of the features that form the seals is performed using a plurality of registration openings (which are typically on at least one, and more typically on at least two or three sides of the pouch) to properly align the pouch to the respective first and second plates. Where desired, co-registration may also be achieved by alternative manners, including optically recognizable indicia (e.g., printed markers or lines), electronically recognizable indicia (e.g., conductive traces), or using manual user intervention. Consequently, it should be appreciated that each of the two stations can independently form respective seals using different process control variables (i.e., different pressure, time, and temperature) to allow optimization of the two sets of geometries.

Alternatively, a heater plate unit may be constructed from multiple and interpedently movable heater plate segments to application of independent and different process control variables. Most typically, such plate units will comprise two segments that are arranged such that the segments formed interleaved pieces. For example, the outer, larger piece may contain the basic pouch and chamber geometries, while the inner, smaller piece may contain the frangible seal geometries. During the pouch forming process, the outer plate is driven down first to form the basic pouch and chambers. At some time during that initial forming process, the second, inner plate is driven down to form the frangible seals. As above, each of these two plates is independently pressure-, time-, and temperature-controlled to allow optimization of the two sets of geometries. It should be noted that the two (or more) plate segments are indexed relative to each other for proper application of seal geometry. Indexing may be performed in numerous manners, however, most preferably, indexing of the two segments is achieved by mutual engagement of elements (e.g., corresponding channels, mating elements, etc.) in the segments to properly align the segments relative to each other. Alternatively, the two or more segments may be coupled to a carrier or frame along which the segments move in predetermined manner.

In another aspect of the inventive subject matter, a single heater plate is employed in the process of forming both permanent and frangible seal, wherein one or more of the heating features in the plate are configured to allow selective temperature control. For example, the heater plate may be configured to include one or more cooling zones at the location of the frangible seal geometries. During the pouch forming process, the plate is driven down to form the basic pouch, chambers, and frangible seals. At some time during that initial forming process, the cooling zone is activated to slow down or even stop the heat forming of the frangible seals. Most typically, each of the zones may be independently controlled using a desired time and/or temperature parameter to allow optimization of the two sets of seal geometries.

Alternatively, individually controlled heating features may be used in a single plate, which may be controlled by a central unit or separately controlled. Where required, feedback sensors may be provided (e.g., on opposite side of the pouch). Among other suitable choices, heating features may include those in which heat is provided by a heat transfer fluid (which advantageously has a relatively high circulation rate to ensure near-constant heat transfer). Such heating features will also allow relatively quick changes in temperature and may even provide a manner of cooling the freshly formed seal. On the other hand, heat may be provided by an electric heater, and all known electric heating elements are deemed suitable herein. For example, contemplated electric heating elements include resistive heaters, inductive heating elements, and Peltier elements, which may also be used for rapid cooling. Additionally contemplated heating elements include those based on electromagnetic radiation (e.g., quartz lamp, laser, infrared source, etc.), and ultrasound application.

Most typically, the heating features are static heating elements (typically protruding from a generally flat surface or other carrier structure) that correspond in shape and number to the geometry of seals to be formed. Alternatively, one or more heated rollers may be used to apply the heat, wherein roller temperature, roller pressure, and/or the rolling speed may at least in part determine the type of seal that is produced. In still further contemplated aspects, at least some of the seals may also be formed using an adhesive (low-tack or permanent), or via crosslinking of polymeric material between polymeric sheets. For example, crosslinking may be performed using electron beam or plasma treatment of areas to be fused.

Regardless of the particular nature of the heating element, it is generally preferred that the heating elements are capable of providing heating within a relatively wide spectrum of temperatures, typically between 50° C. and 400° C., more typically between 50° C. and 400° C., and most typically 50° C. and 400° C. Similarly, it is generally preferred that contemplated heating sources will be able to change the temperature that is applied to the sheet material. For example, preferred temperature change rates will be in the range of at least 10° C./min, more preferably at least 30° C./min, and most preferably at least 60° C./min. Thus, it should be appreciated that the seals may be formed using constant heat at a predetermined temperature, or in a process in which a heat gradient is applied over a predetermined period of time.

A further essential parameter of seal formation is the period of time for which the heat is applied, and it should be noted that time control can be effected in numerous manners. For example, and most preferably, heating time is controlled contact time of the heating plate(s) with the work piece. Alternatively, or additionally, the time for heat application may also be controlled by a control unit that regulates the duration (and optionally temperature, especially where the heating feature is electronic heater). Consequently, it should be noted that the time may be the same for all seals if the heat elements have different temperatures. On the other hand, and especially where two distinct heating plates are employed, the contact time may be used to differentiate between frangible seal formation and permanent seal formation. Pressure control for seal formation is typically a function of the pressure applied to the heater plate(s) and sheets, and it should be recognized that such pressure control can be effected in various manners, which may or may not include active process control using pressure feedback sensors or passive control (using hydraulic actuators, mechanical actuators, etc.). Therefore, it should be appreciated that contemplated methods and devices allow variation of all three determinants (temperature, pressure, and time) in the formation of frangible and permanent seals. Still further, it should be recognized that for multiple and varyingly frangible seals, additional heater plates and/or heating features on one or more plates may be implemented.

In still further contemplated aspects, a counter plate is preferably disposed opposite the heating plate(s), wherein the counter plate and the heating plate(s) are positioned on opposite sides of the sheets that will form the pouch. Most preferably, the counter plate is heat controlled, and/or may have a plurality of depressions with a geometry that corresponds to a desired volume or geometry of a compartment. To accommodate for a desired volume of a compartment in the pouch, the counter plate may be heated to allow plastic deformation of the sheet contacting the counter plate such that the sheet that contacts the plate can conform to the depressions. Typically, such conformation is assisted by application of vacuum.

With respect to suitable pouches it is contemplated that all types and configurations of pouches are deemed suitable. For example, contemplated pouches will have between 2 and 20 compartments and one too several ports that allow addition and/or removal of fluids and/or solids from the pouch. Most typically, the total volume contained in contemplated pouches is between 1 ml and 50 ml, however, larger volumes are not excluded. With respect to the materials it is generally preferred that the material is suitable to allow formation of a flexible pouch (deformable using manual force). However, where desirable, contemplated pouches may be reinforced in at least a portion of may have a backing or housing to impart rigidity in at least a portion of the diagnostic or medical device. Especially preferred pouches are laminated devices in which two flexible polymer sheets are laminated together using seals that will generally define a pouch perimeter, which is typically, but not necessarily non-contiguous to allow fluid import and/or export into the pouch via an opening formed between the laminated sheets. Still further, pouches will generally have numerous compartments and conduits that are coupled to each other and configured to allow unilateral or bidirectional movement of one or more reagents and reagent mixtures. Particularly preferred pouches will also have a plurality of registration elements that allow proper alignment of the pouch during seal formation with the plate(s) and/or during operation with actuators of an analytic device.

Permanent seals produced by the methods described herein will generally have a strength sufficient to resists pressure applied by one or more actuators during operation or pressure during normal handling. Thus, permanent seals will retain a fluid within the confines of the compartment formed by the seals even when the fluid or compartment is pressurized. However, in at least some aspects, it is preferred that the permanent seal will have a strength that allows rupture of the seal under a force that is less than a force to rupture the sheet material. Thus, contemplated pouches will maintain the fluid(s) within the container upon exposure to inadvertent excessive pressure and allow release of the pressure build-up without undesired contamination of an analytical device and/or environment by one or more fluids from the pouch. It should be noted that the term “permanent seal” as used herein means that the seal has a resistance to rupture that is higher than the resistance to rupture of a frangible seal (and where multiple frangible seals are present, resistance to rupture of the strongest of the frangible seals).

Frangible seals may be formed in numerous geometries and may comprise a simple rupture point or distance along a portion of an otherwise permanent seal, or may have more complex configuration. For example, suitable frangible seals may include chevron seals, or breakable seals with flow-control elements (e.g., restrict to unidirectional flow or specific direction). Furthermore, it is generally preferred that the transition of a permanent seal to a frangible seal is typically contiguous and it is especially preferred that heater elements for formation of the frangible seal extend into the permanent seal area. It should be noted that the manner of forming frangible seals is substantially the same as for permanent seals with the exception that at least one of the process parameters is reduced (e.g., temperature, time, and/or pressure) relative to the process parameters for formation of the permanent seal. It should also be noted that while the order of formation of frangible and permanent is not limited, it is generally preferred that the frangible seals are formed prior to formation of the permanent seals.

Thus, specific embodiments and applications of pouch-based diagnostic and medical products with differential heat seal strength have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of producing a pouch having a chamber with a chamber seal and a frangible seal, comprising:
providing a first and second film, wherein the first and second film are substantially non-adherent to each other;
positioning the first and second film such that first and second film contact each other in at least partial overlap;
applying a different process control variable to first and second films to thereby form the chamber and the frangible seal, respectively, wherein the control variable is selected from the set consisting of temperature, pressure, and time.

2. The method of claim 1, further comprising varying at least two of the processes control variables in producing the chamber and frangible seals.

3. The method of claim 1, further comprising varying all three of the processes control variables in producing the chamber and frangible seals.

4. The method of claim 1, further comprising forming basic pouch and chamber geometries of the pouch using a first heater plate, then indexing the pouch to a second heater plate, and forming the frangible seal using the second heater plate.

5. The method of claim 4 wherein the indexing is performed using registration openings that are formed in the pouch.

6. The method of claim 5 wherein the registration openings are also used for registration of the pouch in an analytic device.

7. The method of claim 1, further comprising applying an additional different process control variable to first and second films to thereby form an additional frangible seal, wherein the frangible seal and the additional frangible seal have different opening characteristics.

8. The method of claim 1, wherein the step of applying the different process control variable to first and second films is performed using a heater plate that includes two interleaved pieces in which an outer, larger one of the pieces contains basic pouch and chamber geometries, and in which an inner, smaller one of the pieces contains frangible seal geometries.

9. The method of claim 1, wherein the step of applying the different process control variable to first and second films is performed using a heater plate that includes cooling zone geometries at locations of different frangible seal geometries.

10. The method of claim 1, wherein the step of applying the different process control variable to first and second films is performed using a heater plate that includes heating elements that are separately controlled.

11. The method of claim 10, wherein separate control includes separate control of at least one of heating time and temperature.

12. A pouch manufactured using the method of claim 1.

13. The pouch of claim 12 further comprising registration openings that are formed in the pouch and that are suitable for registration of the pouch in an analytic device.

14. The pouch of claim 12 further comprising an additional frangible seal, wherein the frangible seal and the additional frangible seal have different opening characteristics.
